(19) United States
(12) Patent Application Publication
(10) Pub. No.: US 2018/0222389 A1
(43) Pub. Date: Aug. 9, 2018

(54) METHOD AND APPARATUS FOR ADJUSTING FRONT VIEW IMAGES

(71) Applicant: GM GLOBAL TECHNOLOGY OPERATIONS LLC, Detroit, MI (US)

(72) Inventors: Valor Yaldo, Farmington HIlls, MI (US); Wende Zhang, Troy, MI (US)

(21) Appl. No.: 15/427,223

(22) Filed: Feb. 8, 2017

(51) Int. Cl. B60R 1/00; B60K 35/00; B60R 11/04; H04N 7/18; H04N 5/232; G06T 7/20; G06T 7/60; G06T 7/10; G06K 9/32; G06T 7/70; G06K 9/00

(52) U.S. Cl. CPC B60R 1/00; B60R 2011/004; B60R 11/04; H04N 7/183; H04N 5/23293; G06T 7/20; G06T 7/60; G06T 7/10; G06K 9/325; G06T 7/70; G06K 9/00791; B60R 2300/306; B60R 2300/80; B60K 2350/106; B60K 2350/2013; B60K 2350/352; B60K 35/00

(57) ABSTRACT

A method and apparatus for adjusting front view camera images are provided. The method includes determining whether a front mounted license plate is present; in response to determining that the front mounted license plate is present, adjusting an image of a front view camera to remove a part of the image including an area where the front mounted license plate is present and displaying the adjusted image; and in response to determining that the front mounted license plate is absent, displaying the image of the front view camera including a part of the area where the front mounted license plate would be mounted.

### INTRODUCTION

Apparatuses and methods consistent with exemplary embodiments relate to displaying front view camera images. More particularly, apparatuses and methods consistent with exemplary embodiments relate to processing and displaying front view camera images.

### SUMMARY

One or more exemplary embodiments provide a method and an apparatus that adjust a front view camera image to be displayed to a vehicle operator. More particularly, one or more exemplary embodiments provide a method and an apparatus that crop a front view camera image when a front license plate is detected in the view and that display the cropped image to the vehicle operator, and that display an uncropped image when the front license plate is not detected in the view.

According to an aspect of an exemplary embodiment, a method for adjusting front view camera images is provided. The method includes: determining whether a front mounted license plate is present; in response to determining that the front mounted license plate is present, adjusting the image of a front view camera to remove a part of an image that includes an area where the front mounted license plate is present in the image and displaying the adjusted image; and in response to determining that the front mounted license plate is absent from the image, displaying the image of the front view camera including a part of the area where the front mounted license plate would be mounted.

The determining whether the front mounted license plate is present in the image may include receiving a user selection indicating whether the front mounted license plate is present or absent from the front of the vehicle.

The determining whether the front mounted license plate is present may include detecting a pattern on the front mounted license plate that is present in the image.

The determining whether a front mounted license plate is present may include detecting a shape and a position of the front mounted license plate present in the image and determining that the front mounted license plate is present based on the detected shape and the detected position.

The determining whether the front mounted license plate is present may include detecting motion in the image.

The determining whether the front mounted license plate is present may further includes determining a static portion of the image and a shape of the static portion.

The determining whether the front mounted license plate is present may further include determining that the front mounted license plate is present based on the detected shape of the static portion of the image and detected motion in the image.

The front view camera may be mounted in at least one from among a front bumper of a vehicle, a front grille of a vehicle, and a front hood of a vehicle.

The method may further include receiving the image from the front view camera.

According to an aspect of another exemplary embodiment, an apparatus for augmenting a rear view display, the apparatus includes: at least one memory comprising computer executable instructions; and at least one processor configured to read and execute the computer executable instructions. The computer executable instructions cause the at least one processor to: determine whether a front mounted license plate is present; in response to determining that the front mounted license plate is present, adjust an image of a front view camera to remove a part of the image including an area where the front mounted license plate is present and control to display the adjusted image; and in response to determining that the front mounted license plate is absent, display the image of the front view camera with a wider field of view than the adjusted image.

The computer executable instructions may cause the at least one processor to determine whether a front mounted license plate is present by receiving a user selection indicating whether the front mounted license plate is present or absent from the front of the vehicle.

The computer executable instructions may cause the at least one processor to determine whether a front mounted license plate is present by detecting a pattern on the front mounted license plate present in the image.

The computer executable instructions may cause the at least one processor to determine whether a front mounted license plate is present by detecting a shape and a position of the front mounted license plate present in the image and determining that the front mounted license plate is present based on the detected shape and the detected position.

The computer executable instructions may cause the at least one processor to determine whether the front mounted license plate is present by detecting motion in the image.

The computer executable instructions may further cause the at least one processor to determine whether the front mounted license plate is present by determining a static portion of the image and a shape of the static portion.

The computer executable instructions may further cause the at least one processor to determine whether the front mounted license plate is present by determining that the front mounted license plate is present based on the detected shape of the static portion of the image and the detected motion in the image.

The apparatus may further include the front view camera. The front view camera may be mounted in at least one from among a front bumper of a vehicle, a front grille of a vehicle, and a front hood of a vehicle.

The computer executable instructions may cause the at least one processor to receive the image from the front view camera.

According to an aspect of another exemplary embodiment, a non-transitory computer readable medium comprising computer executable instructions executable by a processor to perform a method for adjusting front view camera images of a vehicle is provided. The method includes: determining whether a front mounted license plate is present; in response to determining that the front mounted license plate is present, cropping an image of a front view camera to remove at least a part of the front mounted license plate from the image and displaying the cropped image; and in response to determining that the front mounted license plate is absent, displaying the image of the front view camera.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that adjusts front view camera images according to an exemplary embodiment;

FIG. 2 shows a flowchart for a method of adjusting front view camera images according to an exemplary embodiment;

FIG. 3 shows a flowchart for a method of adjusting front view camera images according to another exemplary embodiment; and

FIG. 4 shows illustrations of example views from a front view camera according to an aspect of an exemplary embodiment.

### DETAILED DESCRIPTION OF EXEMPLARY EMBODIMENTS

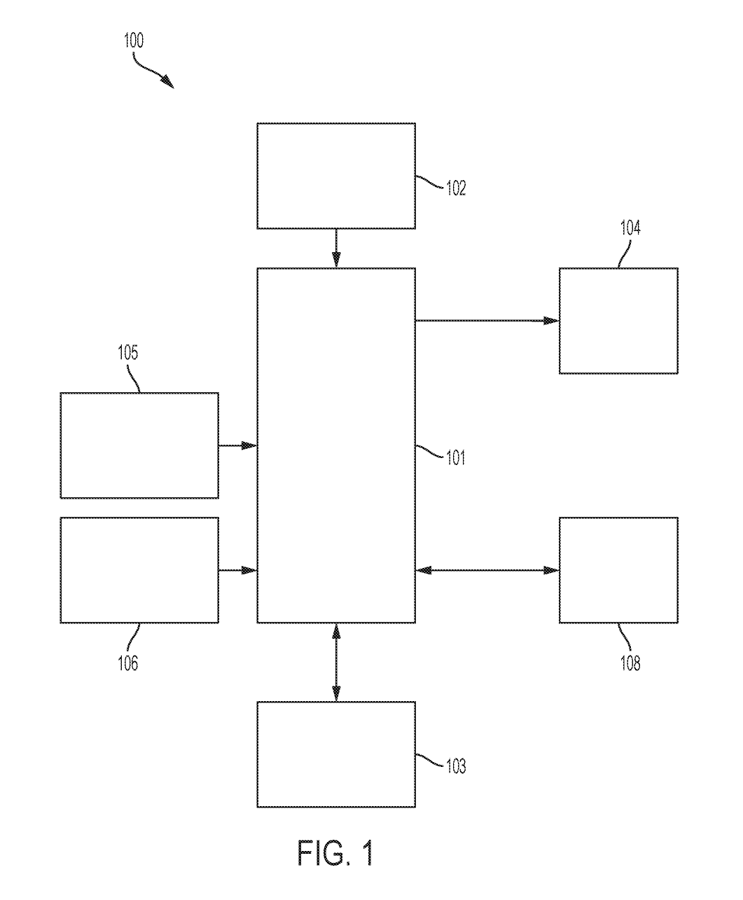

An apparatus and method that adjust a front view camera image will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles, such as cars and trucks, may include front view cameras that provide images of the road ahead and/or obstacles in the road ahead. These images may be used by an operator of the vehicle or by autonomous vehicles to control the vehicle. In some vehicles, the image of a front view camera may be partially obscured or obstructed by a front mounted license plate. One way to address the obstruction caused by the front mounted license plate is to modify or adjust the image to remove the front mounted license plate from the image, e.g., by cropping the image or enlarging the unobscured portion of the image. However, cropping or enlarging the image reduces the field of view of the image, which removes details on the edges of the image from the view of the operator of the vehicle.

In addition, where a front mounted license plate is not present, the obstacles and details present on the edges of the image may be helpful to an operator or to an autonomous vehicle's decision making algorithm. For example, leaving the image uncropped when the front mounted license plate is not present would be useful. Thus, it may be possible to provide two different images to an operator of a vehicle or autonomous vehicle control system from the front view camera depending on whether or not a front mounted license plate is present or obscuring a portion of the field of view of the image of the front view camera.

FIG. 1 shows a block diagram of an apparatus that adjusts a front view camera image 100 according to an exemplary embodiment. As shown in FIG. 1, the apparatus that adjusts a front view camera image 100, according to an exemplary embodiment, includes a controller 101, a power supply 102, a storage 103, an output 104, a front view camera 105, a user input 106 and a communication device 108. However, the apparatus that adjusts a front view camera image 100 is not limited to the aforementioned configuration and may be configured to include additional elements and/or omit one or more of the aforementioned elements. The apparatus that adjusts a front view camera image 100 may be implemented as part of a vehicle, as a standalone component, as a hybrid between an on vehicle and off vehicle device, or in another computing device.

The controller 101 controls the overall operation and function of the apparatus that adjusts a front view camera image 100. The controller 101 may control one or more of a storage 103, an output 104, a front view camera 105, a user input 106, and a communication device 108 of the apparatus that adjusts a front view camera image 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 may be configured to send and/or receive information from one or more of the storage 103, the output 104, the front view camera 105, the user input 106, and the communication device 108 of the apparatus that adjusts a front view camera image 100. The information may be sent and received via a bus or network, or may be directly read or written to/from one or more of the storage 103, the output 104, the user input 106, and the communication device 108 of the apparatus that adjusts a front view camera image 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the front view camera 105, the user input 106, and the communication device 108, of the apparatus that adjusts a front view camera image 100. The power supply 102 may include one or more from among a battery, an outlet, a capacitor, a solar energy cell, a generator, a wind energy device, an alternator, etc.

The storage 103 is configured for storing information and retrieving information used by the apparatus that adjusts a front view camera image 100. The storage 103 may be controlled by the controller 101 to store and retrieve information received from the front view camera 105. The information may include information and/or one or more images taken by the front view camera 105. In addition, the storage 103 may also include the computer instructions configured to be executed by a processor to perform the functions of the apparatus that adjusts a front view camera image 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that adjusts a front view camera image 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an instrument panel display, a center stack display, a rear view mirror display, a side view mirror display, an indicator light, etc.

According to one example, the output 104 may be one or more from among a center stack display, a side mirror display, or a rear view mirror display. The output 104 may be configured to output an image from the front view camera 105. In addition, the output 104 may output notifications including one or more from among an audible notification, a light notification, and a display notification. The notification may include information indicating that the front view camera 105 is providing an obscured or obstructed image, information asking an operator to indicate whether a front mounted license plate is present on a vehicle, information requesting an operator to select an area of an image of the front view camera 105 that is to be cropped when a front mounted license plate is present.

The user input 106 is configured to provide information and commands to the apparatus that adjusts a front view camera image 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to cycle between display modes of the output 104. For example, the user input 106 may be configured to select an uncropped and/or unadjusted image from the front view camera 105 to be output or a cropped and/or adjusted image from the front view camera 105 to be output. In another example, the user input 106 may be configured to receive a selection of an area of the image from the front view camera 105 to be displayed or processed.

The front view camera 105 may be one or more from among a camera, an infrared camera, or a nightvision camera. According to an example, the front view camera 105 may be mounted on a bumper, a hood, a grille, or a dashboard of the vehicle. The images from the front view camera 105 may be analyzed to determine whether they are obstructed or obscured. According to an example, the image from the front view camera may be zoomed into an unobscured portion, cropped to show only an unobscured portion, or unadjusted to show the full view of the front view camera 105.

The communication device 108 may be used by apparatus that adjusts a front view camera image 100 to communicate with various types of external apparatuses according to various communication methods. The communication device 108 may be used to send/receive image information to/from the front view camera 105. In addition, the communication device 108 may be send image information to the output 104 to be output on a display of the apparatus that adjusts a front view camera image 100.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long term evolution (LTE), Bluetooth, EVDO, CDMA, GPRS, EDGE or ZigBee.

According to an example, the controller 101 of the apparatus that adjusts a front view camera image 100 may be configured to determine whether a front mounted license plate is present, in response to determining that the front mounted license plate is present, adjust an image of a front view camera to remove a part of the image including an area where the front mounted license plate is present and control to display the adjusted image, and in response to determining that the front mounted license plate is absent, display the image of the front view camera with a wider field of view than the adjusted image.

According to an example, the controller 101 of the apparatus that adjusts a front view camera image 100 may be configured to determine whether a front mounted license plate is present, in response to determining that the front mounted license plate is present, crop an image of a front view camera to remove at least a part of the front mounted license plate from the image and display the cropped image, and in response to determining that the front mounted license plate is absent, display the image of the front view camera.

The controller 101 of the apparatus that adjusts a front view camera image 100 may be configured to receive the image from the front view camera.

The controller 101 may be configured to determine whether the front mounted license plate is present according to image detection algorithms and/or a user input, etc. In one example, the controller 101 may be configured to determine whether a front mounted license plate is present by receiving a user selection indicating whether the front mounted license plate is present or absent from the front of the vehicle. In another example, the controller 101 may be configured to determine whether a front mounted license plate is present by detecting a pattern on the front mounted license plate present in the image. In yet another example, the controller 101 may be configured to determine whether a front mounted license plate is present by detecting a shape and a position of the front mounted license plate present in the image and determining that the front mounted license plate is present based on the detected shape and the detected position.

Moreover, the controller 101 may be configured to determine whether the front mounted license plate is present by detecting motion in the image, and determining a static portion of the image and a shape of the static portion. Further, the controller 101 may then be configured to determine that the front mounted license plate is present based on the detected shape of the static portion of the image and the detected motion in the image.

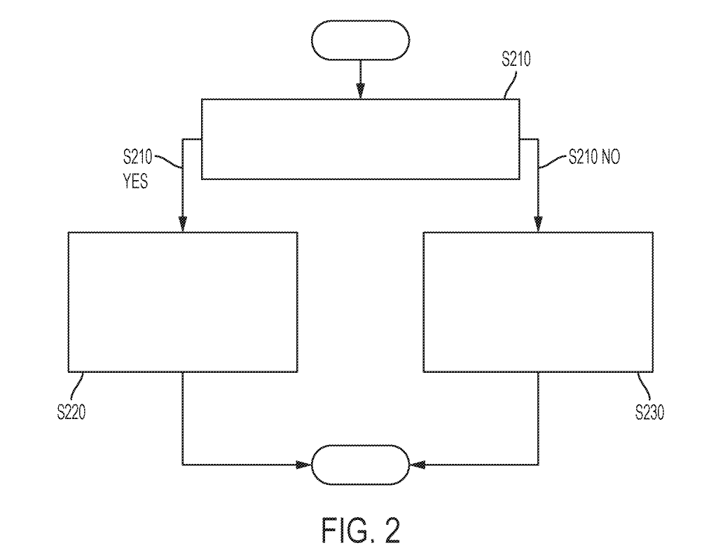

FIG. 2 shows a flowchart for a method for adjusting front view camera images according to an exemplary embodiment. The method of FIG. 2 may be performed by the apparatus that adjusts a front view camera image 100 or may be encoded into a computer readable medium as instructions that are executable by a computer to perform the method.

Referring to FIG. 2, it is determined whether a front mounted license plate or other obscuring object is present in an image of a camera in operation 210. For example, an image analysis may be performed on the image or an operator may make a selection from a menu to indicate a front mounted license plate or other obscuring object is present.

If a front mounted license plate or obscuring object is present (operation S210-Yes), the image of front view camera is adjusted to remove a part of image that includes an area where front mounted license plate or obscuring object is present and the adjusted image is displayed in operation S220. For example, the unobscured area of the image may be enlarged to show only the unobscured part of the image on a display

If a front mounted license plate is not present (operation S210-No), the image of front view camera including part of area where front mounted license plate or obscuring object would be mounted is displayed in operation S230. In other words, the entire image may be displayed.

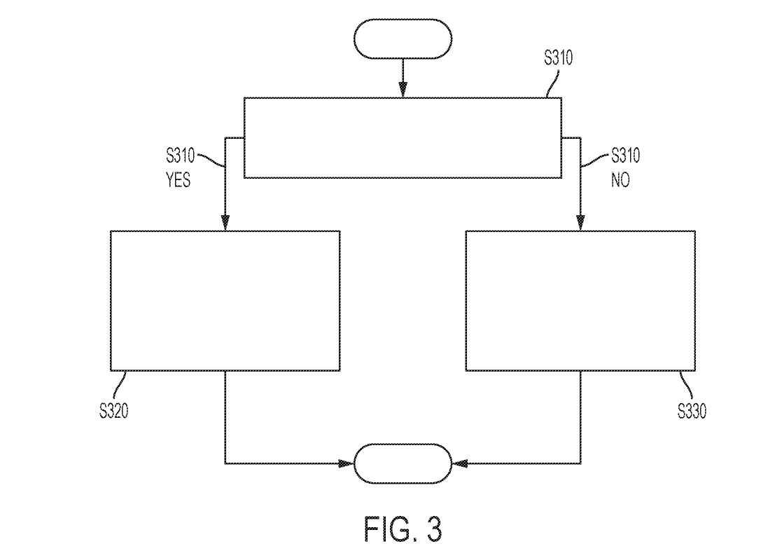

FIG. 3 shows a flowchart for a method for adjusting front view camera images according to another exemplary embodiment. The method of FIG. 3 may be performed by the apparatus that adjusts a front view camera image 100 or may be encoded into a computer readable medium as instructions that are executable by a computer to perform the method.

Referring to FIG. 3 it is determined whether a front mounted license plate or other obscuring object is present in an image of a camera in operation 310. For example, an image analysis may be performed on the image or an operator may make a selection from a menu to indicate a front mounted license plate is present.

If a front mounted license plate is present (operation 310-Yes), the image of front view camera is cropped to remove a part of image that includes an area where front mounted license plate is present and the cropped image is displayed in operation S320.

If a front mounted license plate is not present (operation S310-No), the image of front view camera is displayed in operation S330. In other words, the entire unadjusted image may be displayed.

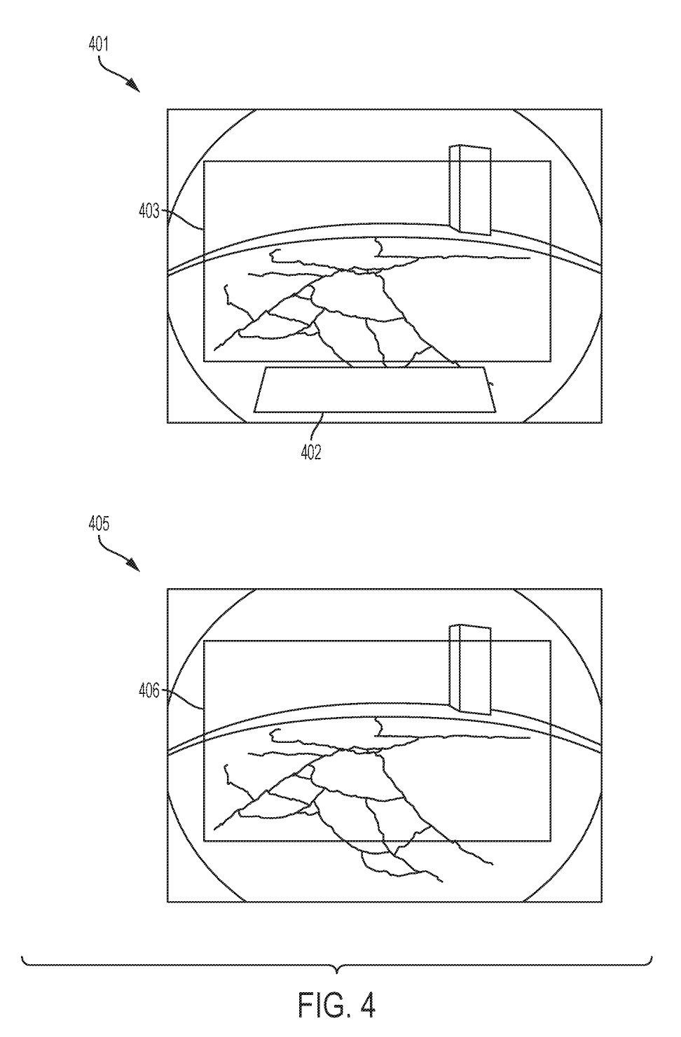

FIG. 4 shows illustrations of example views from a front view camera according to an aspect of an exemplary embodiment. Referring to FIG. 4, a first image 401 showing the obscuring front mounted license plate 402 in the first image 401. A front view camera 105 may take the first image 401. The cropped area 403 is the area of the image that may be presented on the display to provide a better view by removing a part of the first image 401 that includes the front mounted license plate.

A second image 405 is shown in a situation where a front mounted license plate 402 is not present on a vehicle. In this case, a better view may be provided to an operator by not cropping the image to cropped area 406 and providing an operator with an expanded field of view in second image 405. In other words, a larger portion of the area in the circle can be displayed on a display including a part of the rectangular object that would otherwise be cropped by cropped areas 403 and 406.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for adjusting front view camera images, the method comprising:
determining whether a front mounted license plate is present;
in response to determining that the front mounted license plate is present, adjusting an image of a front view camera to remove a part of the image that includes an area where the front mounted license plate is present and displaying the adjusted image; and
in response to determining that the front mounted license plate is absent, displaying the image of the front view camera including a part of the area where the front mounted license plate would be mounted.

2. The method of claim 1, wherein the determining whether a front mounted license plate is present comprises receiving a user selection indicating whether the front mounted license plate is present or absent from the front of the vehicle.

3. The method of claim 1, wherein the determining whether a front mounted license plate is present comprises detecting a pattern on the front mounted license plate present in the image.

4. The method of claim 1, wherein the determining whether a front mounted license plate is present comprises detecting a shape and a position of the front mounted license plate present in the image and determining that the front mounted license plate is present based on the detected shape and the detected position.

5. The method of claim 1, wherein the determining whether the front mounted license plate is present comprises detecting motion in the image.

6. The method of claim 5, wherein the determining whether the front mounted license plate is present further comprises determining a static portion of the image and a shape of the static portion.

7. The method of claim 6, wherein the determining whether the front mounted license plate is present further comprises determining that the front mounted license plate is present based on the detected shape of the static portion of the image and detected motion in the image.

8. The method of claim 1, wherein the front view camera is mounted in at least one from among a front bumper of a vehicle, a front grille of a vehicle, and a front hood of a vehicle.

9. The method of claim 1, further comprising
receiving the image from the front view camera.

10. A non-transitory computer readable medium comprising computer executable instructions executable by a processor to perform the method of claim 1.

11. An apparatus for augmenting a rear view display, the apparatus comprising:
at least one memory comprising computer executable instructions; and
at least one processor configured to read and execute the computer executable instructions, the computer executable instructions causing the at least one processor to:
determine whether a front mounted license plate is present;
in response to determining that the front mounted license plate is present, adjust an image of a front view camera to remove a part of the image including an area where the front mounted license plate is present and control to display the adjusted image; and
in response to determining that the front mounted license plate is absent, display the image of the front view camera with a wider field of view than the adjusted image.

12. The apparatus of claim 11, wherein the computer executable instructions cause the at least one processor to determine whether a front mounted license plate is present by receiving a user selection indicating whether the front mounted license plate is present or absent from the front of the vehicle.

13. The apparatus of claim 11, wherein the computer executable instructions cause the at least one processor to determine whether a front mounted license plate is present by detecting a pattern on the front mounted license plate present in the image.

14. The apparatus of claim 11, wherein the computer executable instructions cause the at least one processor to determine whether a front mounted license plate is present by detecting a shape and a position of the front mounted license plate present in the image and determining that the front mounted license plate is present based on the detected shape and the detected position.

15. The apparatus of claim 11, wherein the computer executable instructions cause the at least one processor to determine whether the front mounted license plate is present by detecting motion in the image.

16. The apparatus of claim 15, wherein the computer executable instructions further cause the at least one processor to determine whether the front mounted license plate is present by determining a static portion of the image and a shape of the static portion.

17. The apparatus of claim 16, wherein the computer executable instructions further cause the at least one processor to determine whether the front mounted license plate is present by determining that the front mounted license plate is present based on the detected shape of the static portion of the image and the detected motion in the image.

18. The apparatus of claim 11, further comprising the front view camera,
wherein the front view camera is mounted in at least one from among a front bumper of a vehicle, a front grille of a vehicle, and a front hood of a vehicle.

19. The apparatus of claim 18, wherein the computer executable instructions cause the at least one processor to receive the image from the front view camera.

20. A non-transitory computer readable medium comprising computer executable instructions executable by a processor to perform a method for adjusting front view camera images of a vehicle, the method comprising:
determining whether a front mounted license plate is present;
in response to determining that the front mounted license plate is present, cropping an image of a front view camera to remove at least a part of the front mounted license plate from the image and displaying the cropped image; and
in response to determining that the front mounted license plate is absent, displaying the image of the front view camera.
